(19) United States
(12) Patent Application Publication
(10) Pub. No.: US 2026/0281553 A1
(43) Pub. Date: Sep. 17, 2026

(54) STABILIZING-FOCUSING MOTOR AND APPLICATION MODULE THEREOF

(71) Applicant: VISTA INNOTECH LIMITED, Hong Kong (HK)

(72) Inventors: Lin Chi Mak, Hong Kong (HK); Jing Li, Shenzhen, Guangdong (CN)

(21) Appl. No.: 19/681,162

(22) Filed: May 19, 2026

Related U.S. Application Data
(63) Continuation-in-part of application No. 18/229,190, filed on Aug. 2, 2023, now abandoned.

(30) Foreign Application Priority Data
Aug. 5, 2022 (CN) 202210941255.2

(51) Int. Cl. H04N 23/68; G02B 7/02; G02B 7/09; H04N 23/51; H04N 23/55

(52) U.S. Cl. CPC H04N 23/685; G02B 7/023; G02B 7/09; H04N 23/51; H04N 23/55; H04N 23/6812

(57) ABSTRACT

The present disclosure relates to a technical field of camera modules, and in particular to a stabilizing-focusing motor and an application module thereof. The stabilizing-focusing motor includes a stabilizing structure and a focusing structure, where the stabilizing structure includes an outer ball holder, an inner ball holder, balls, a stabilizing magnet, a stabilizing coil, and a stabilizing circuit board; and the focusing structure includes a second magnet holder, a lens carrier, a connecting spring, a focusing magnet, a focusing coil, and a focusing circuit board. The present disclosure can provide a multi-axis degree of freedom (DOF), reduce power consumption and a size of a micro gimbal stabilizer (MGS) camera module, lessen impacts of an attitude error on stabilization performance, make assembly less difficult, and increase a maximum stabilizing angle.

### CROSS REFERENCE TO RELATED APPLICATIONS

The present application is a Continuation-In-Part Application of U.S. Application No. 18/229,190 filed on August 2, 2023, which claims the benefit of Chinese Patent Application No. 202210941255.2 filed on August 5, 2022, the contents of which are incorporated herein by reference in their entirety.

### TECHNICAL FIELD

The present disclosure relates to a technical field of camera modules, and in particular to a stabilizing-focusing motor and an application module thereof.

### BACKGROUND

In recent years, compact mobile devices having a photographing function, including smartphones, smart glasses, sports cameras, body-worn cameras, and automobile data recorders, have been popularized and applied to more fields. The compact mobile device includes at least one zoom, auto-focus, or fixed-focus compact camera module. Hence, there are a huge market and a rising trend for the module.

When the compact mobile device is used to take photos and films, the photos and films are prone to blurs or drifts due to external vibrations, with an undesirable quality. This problem is particularly severe in the case of intense vibrations or low-light scenarios.

In order to solve problems above, different stabilizer techniques are emergent in markets. Existing mainstream techniques are implemented by reading a vibration sensor (such as a gyroscope and an acceleration sensor), calculating a vibration waveform and a required compensating angle, and making compensations electronically, optically, or mechanically for image blurs and drifts caused by the vibrations, thereby improving the image quality.

In terms of vibration compensation methods, there are an electronic image stabilizer (EIS), an optical image stabilizer (OIS), a sensor-shift stabilizer (SSS), and a gimbal stabilizer (GS) in the prior art. The EIS, OIS, SSS, and GS have their distinct advantages and disadvantages.

The EIS achieves a stabilization effect with an electronic method. During photographing, each frame of image is adjusted by the EIS according to a calculated vibration waveform to counteract the image drifts due to the vibrations. Because of no additional actuator, the EIS mainly has advantages of low cost and no additional weight and size.

The OIS works with an optical and mechanical method. It shifts an optical component with an actuator, such that the optical component moves relative to an image sensor to change an optical path and a position of an image circle, thereby counteracting the image drifts due to the vibrations. The OIS achieves a better image quality than the EIS, because optical stabilizing compensations are made constantly for each frame of image in photographing to counteract jitters in each frame of image in an exposure.

The SSS works with a mechanical method. It shifts an image sensor with an actuator, such that the optical component and the image sensor move relatively to counteract the image drifts due to the vibrations. Similar to the OIS in optical stabilizing principle and effect, the SSS can counteract jitters in each frame of image in an exposure to achieve a better image quality than the EIS. Compared with the OIS, without moving the heavy lens during stabilization, the SSS is more advantageous for high-frequency stabilization effect and power consumption. In addition, the SSS can compensate roll jitters unfulfillable to the OIS, and can achieve five-axis stabilization better than four-axis stabilization of the OIS.

The mainstream GS mechanically drives a whole camera module, including a lens and an image sensor, to make movements in a reverse direction but a close amplitude with vibrations, thereby counteracting the drifts due to the vibrations. Because of no relative movement between the optical component and the image sensor in stabilization, both the image quality and the stabilization effect are not affected at an edge of the image, and neither an optical resolution of the lens nor an optical resolution of the image sensor is compromised for the stabilization. Therefore, the mainstream GS has the better stabilization effect and image quality over the EIS, OIS and SSS.

As can be seen, common camera module devices in the markets have their problems, and there hasn't been a technology that can integrate advantages of the camera module devices and overcome defects of the camera module devices.

### SUMMARY

An objective of the present disclosure is to provide a stabilizing-focusing motor and an application module thereof. The present disclosure has advantages of desirable stabilization effect, low production difficulty, low cost, small size, low power consumption, and the like, and can support roll stabilizing and focusing functions.

In order to solve the above-mentioned technical problems, the present disclosure provides a stabilizing-focusing motor, including:

a stabilizing structure including an outer ball holder, an inner ball holder, balls, a stabilizing magnet, a stabilizing coil, and a stabilizing circuit board, where the inner ball holder is provided in the outer ball holder, and connected to the outer ball holder through the balls; the stabilizing magnet is provided on the inner ball holder; the stabilizing coil is provided on the outer ball holder, and opposite to the stabilizing magnet; and the stabilizing circuit board is provided on the outer ball holder, and electrically connected to the stabilizing coil; and

a focusing structure including a second magnet holder, a lens carrier, a connecting spring, a focusing magnet, a focusing coil, and a focusing circuit board, where the second magnet holder is connected to the inner ball holder; the focusing magnet is provided on the second magnet holder; the lens carrier is connected to the second magnet holder through the connecting spring; the focusing coil is provided on the lens carrier; and the focusing circuit board is provided on the lens carrier, and electrically connected to the focusing coil;

at least four spherical segments in one-to-one correspondence with the balls are arranged at a periphery of the inner ball holder, a center of each of the spherical segments coincides with a center of rotation, and a minimum distance between the center of rotation and an optical axis Z of a lens is less than or equal to 20% of a diameter of a cross-section of the stabilizing-focusing motor.

Preferably, the outer ball holder is provided with at least two portions; the at least two portions are spliced up and down; there are two sets of the balls; and the two sets of the balls are provided on the at least two portions of the outer ball holder in one-to-one correspondence; and

a horizontal plane of a center of rotation is defined as a first reference plane, and one set of the two sets of the balls is located above the first reference plane, while the other one set of the two sets of the balls is located under the first reference plane.

Preferably, the two sets of the balls each include two balls; the two balls above the first reference plane are opposite to each other; and the two balls under the first reference plane are adjacent to the two balls above the first reference plane.

Preferably, the stabilizing structure further includes a holder provided on the outer ball holder, and configured to locate each of the balls.

Preferably, the stabilizing structure further includes a first magnet holder provided on the inner ball holder; and the stabilizing magnet is provided on the first magnet holder.

Preferably, the stabilizing structure further includes a first coil holder provided on the outer ball holder; and the stabilizing coil is provided on the first coil holder.

Preferably, the focusing structure further includes a spring holder provided on the second magnet holder; and the connecting spring is provided on the spring holder.

In order to solve the above-mentioned problems, the present disclosure further provides an application module of a stabilizing-focusing motor, including the stabilizing-focusing motor described above, and further including:

a lens provided on the lens carrier;

an image module provided at a bottom end of the lens carrier, and corresponding to the lens;

a module housing connected to a bottom end of the outer ball holder; and

a module circuit board provided in the module housing, and connected to the focusing structure and the stabilizing structure.

Preferably, the image module includes a sensor housing, an optical filter, an image sensor, and a sensor circuit board; the sensor housing is connected to the focusing structure; the optical filter and the sensor circuit board are provided on the sensor housing; and the image sensor is provided on the sensor circuit board.

Preferably, the module circuit board includes a movable portion, an unmovable portion, and an elastic portion; and the movable portion is connected to the unmovable portion through the elastic portion.

The present disclosure has the following beneficial effects:

The stabilizing-focusing motor and the application module thereof provided by the present disclosure are structured simply, can support multi-axis movement and stabilization, and can be more advantageous in size, reliability and cost.

The stabilizing-focusing motor and the application module thereof provided by the present disclosure employ an electromagnetic force driving actuator, rather than a complicated mechanical transmission structure, and thus have advantages of simple and compact structure, convenience in assembly, small size, light weight, low cost and low power consumption for large-scale production and application.

The outer ball holder is connected to the inner ball holder through the balls. Since the outer ball holder and the inner ball holder are unnecessarily connected by other structures, the stabilizing-focusing motor and the application module thereof provided by the present disclosure have advantages of simple and compact structure, low manufacturing cost, light weight and small size.

The stabilizing-focusing motor and the application module thereof provided by the present disclosure further drive the focusing structure with an Ampere force generated by the powered focusing coil in a magnetic field of the focusing magnet, and controls a direction of a current in the focusing coil in combination with an external or internal control driver chip, thereby realizing an auto-focusing function of the lens, and making the focusing quick and accurate.

### BRIEF DESCRIPTION OF THE DRAWINGS

FIG. 1 is a schematic structural view of a stabilizing-focusing motor and an application module thereof according to an embodiment of the present disclosure;

FIG. 2 is an exploded view of a stabilizing-focusing motor and an application module thereof according to an embodiment of the present disclosure;

FIG. 3 is a top view of a stabilizing-focusing motor and an application module thereof according to an embodiment of the present disclosure;

FIG. 4 is a cross-sectional view taken along line A-A of FIG. 3 according to the embodiment of the present disclosure;

FIG. 5 is a cross-sectional view taken along line B-B of FIG. 3 according to the embodiment of the present disclosure;

FIG. 6 is a cross-sectional view taken along line C-C of FIG. 3 according to the embodiment of the present disclosure;

FIG. 7 is an exploded view of a stabilizing structure according to an embodiment of the present disclosure;

FIG. 8 is a schematic structural view of an inner ball holder and balls according to an embodiment of the present disclosure;

FIG. 9 is an exploded view of a focusing structure according to an embodiment of the present disclosure; and

FIG. 10 is a schematic structural view of a sensor circuit board.

Reference numerals:

100: stabilizing structure;

1: outer ball holder, 1a: fulcrum of rotation, 2: inner ball holder, 3: ball, 4: stabilizing magnet, 5: stabilizing coil, 6: stabilizing circuit board, 7: first coil holder, 8: first magnet holder, 9: holder, and 15: position sensor;

200: focusing structure;

10: second magnet holder, 11: lens carrier, 12: connecting spring, 13: focusing magnet, 14: focusing coil, 16: focusing circuit board, 17: position magnet, 25: spring holder, 26: first reference plane; 27: center of rotation; and 28: spherical segment;

300: lens;

400: image module;

18: sensor housing, 19: optical filter, 20: image sensor, and 21: sensor circuit board;

500: module housing;

600: module circuit board; and

22: movable portion, 23: unmovable portion, 24: elastic portion, and 24a: curved portion.

### DETAILED DESCRIPTION

The technical solutions in the embodiments of the present disclosure are clearly and completely described below with reference to the drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts should fall within the protection scope of the present disclosure.

In the description of the present disclosure, it needs to be understood the orientation or positional relationships indicated by the terms "center", "upper", "lower", "front", "rear", "left", "right", "vertical", "horizontal", "top", "bottom", "inside", "outside", etc. are based on the orientation or positional relationship shown in the accompanying drawings, are merely for facilitating the description of the present disclosure and simplifying the description, rather than indicating or implying that an apparatus or element referred to must have a particular orientation or be constructed and operated in a particular orientation, and therefore will not be interpreted as limiting the present disclosure.

In the description of the present disclosure, it should be noted that, unless otherwise clearly specified, meanings of terms "install", "connected with", and "connected to" should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand the specific meanings of the above terms in the present disclosure based on specific situations.

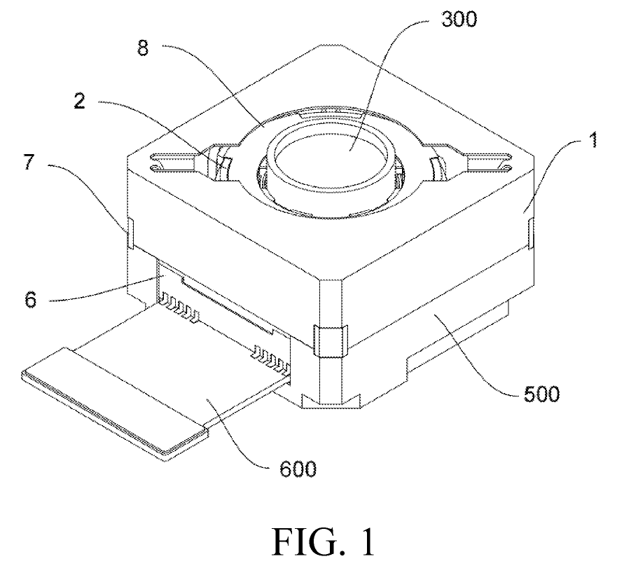

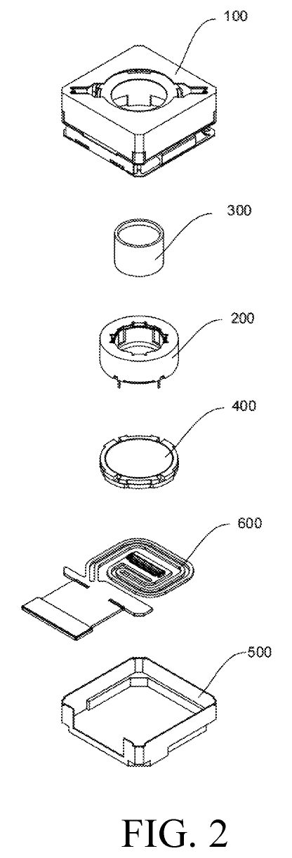

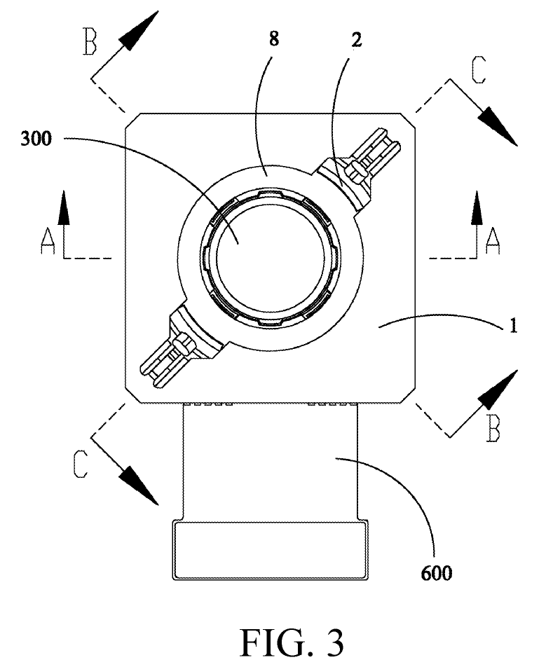

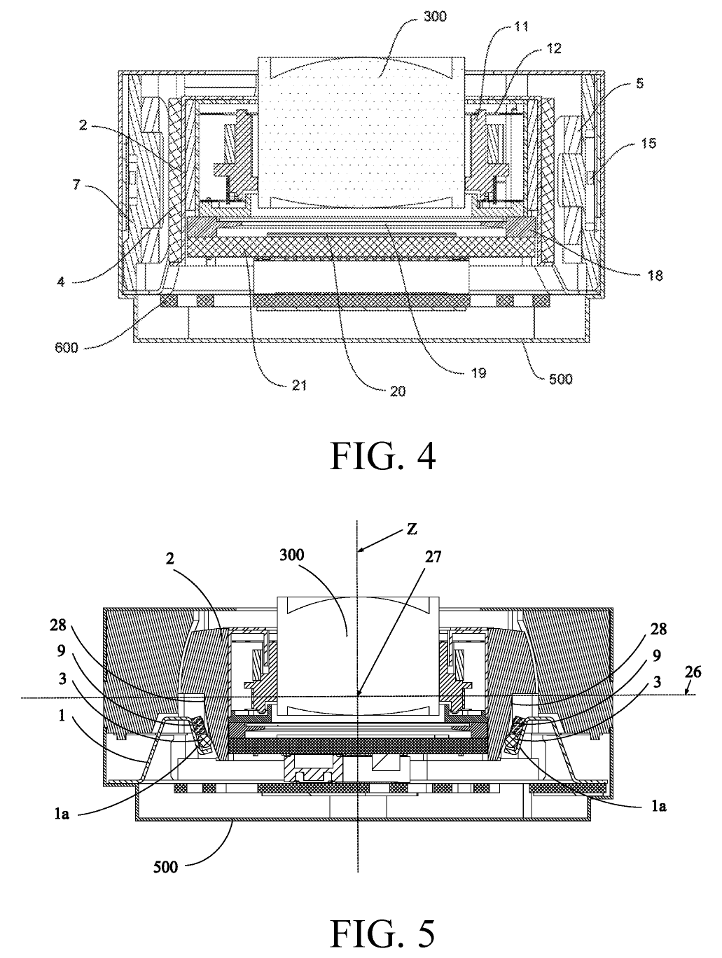

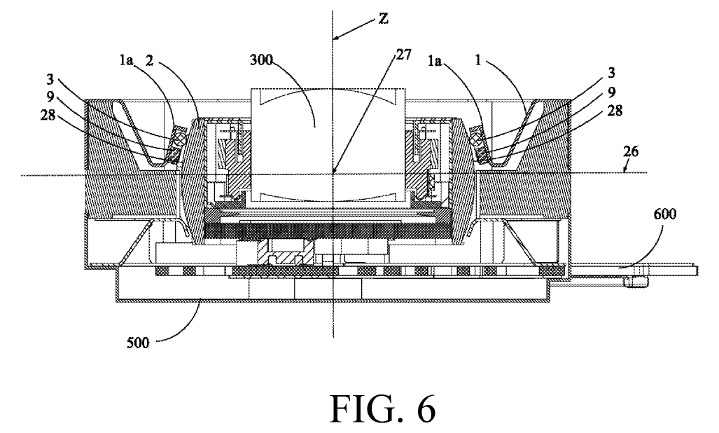

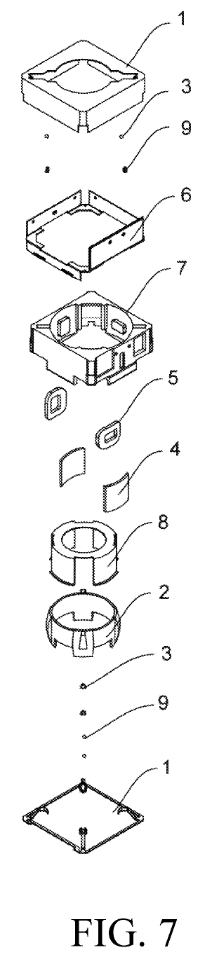

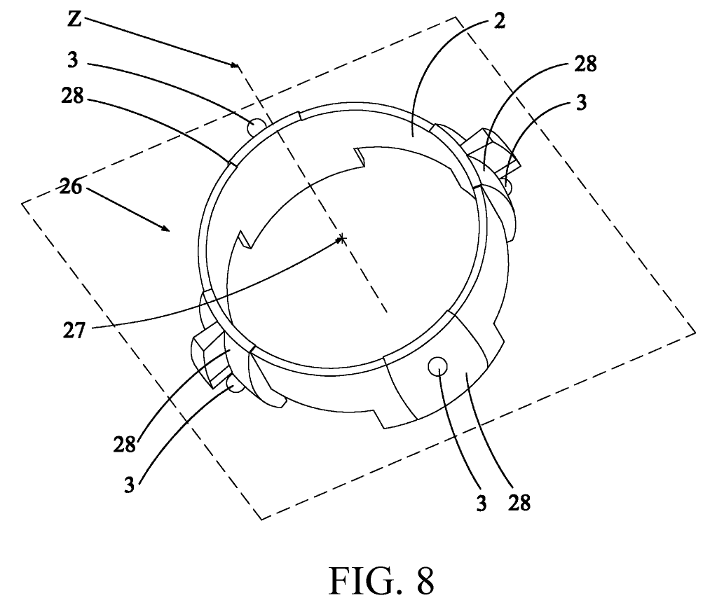

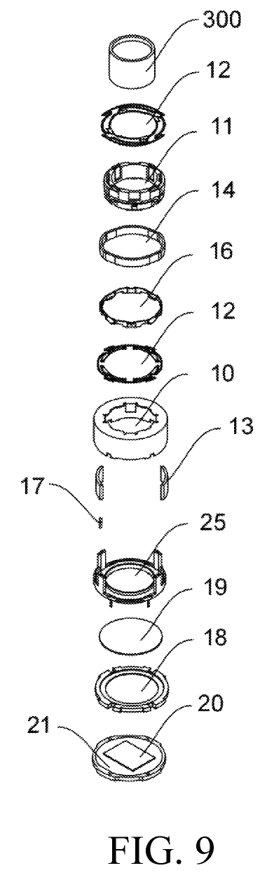

Referring to FIGS. 1-10, a preferred embodiment of the present disclosure provides a stabilizing-focusing motor and an application module thereof. The stabilizing-focusing motor includes a stabilizing structure 100 and a focusing structure 200. The stabilizing structure 100 includes an outer ball holder 1, an inner ball holder 2, balls 3, a stabilizing magnet 4, a stabilizing coil 5, and a stabilizing circuit board 6. The inner ball holder 2 is provided in the outer ball holder 1, and connected to the outer ball holder 1 through the balls 3. The stabilizing magnet 4 is provided on the inner ball holder 2. The stabilizing coil 5 is provided on the outer ball holder 1, and opposite to the stabilizing magnet 4. The stabilizing circuit board 6 is provided on the outer ball holder 1, and electrically connected to the stabilizing coil 5.

The focusing structure 200 includes a second magnet holder 10, a lens carrier 11, a connecting spring 12, a focusing magnet 13, a focusing coil 14, and a focusing circuit board 16. The second magnet holder 10 is connected to the inner ball holder 2. The focusing magnet 13 is provided on the second magnet holder 10. The lens carrier 11 is connected to the second magnet holder 10 through the connecting spring 12. The focusing coil 14 is provided on the lens carrier 11. The focusing circuit board 16 is provided on the lens carrier 11, and electrically connected to the focusing coil 14.

Based on the above solution, in response to stabilization in photographing, the stabilizing coil 5 is powered on. An Ampere force generated by the powered stabilizing coil 5 in a magnetic field of the stabilizing magnet 4 is applied to the inner ball holder 2, such that the inner ball holder 2 moves relative to the outer ball holder 1 under an action of the balls 3. In combination with an external or internal control driver chip, a direction and an amplitude of a current in the stabilizing coil 5 are controlled, thereby controlling an angle of the inner ball holder 2, counteracting vibration interferences in photographing to eliminate the blur of the image, and improving a quality of the image or film. In response to focusing in photographing, an Ampere force generated by the powered focusing coil 14 in a magnetic field of the focusing magnet 13 is applied to the lens carrier 11. In combination with the external or internal control driver chip, a direction and an amplitude of a current in the focusing coil 14 are controlled, thereby controlling a displacement of the lens carrier 11, and realizing an auto-focusing function of the lens. Upon completion of photographing, the lens carrier 11 is reset automatically with the connecting spring 12.

It is to be noted that the stabilizing circuit board 6 and the focusing circuit board 16 are connected to an external power supply through the application module. A control driver chip and a vibration sensor are provided inside/outside the motor. The control driver chip and the vibration sensor are connected to the stabilizing circuit board 6 and/or the focusing circuit board 16. In this way, the control driver chip can read the vibration sensor, calculate a stabilizing angle and a focusing displacement, and output a control signal to change the direction of the current in the stabilizing coil 5 and the focusing coil 14, thereby achieving stabilizing and focusing effects. The lens carrier 11 is connected to a sensor housing 18 through the connecting spring 12 and the second magnet holder 10. Hence, the lens carrier 11 has at least a translational degree of freedom (DOF) relative to the sensor housing 18.

In addition, two portions of the outer ball holder 1 are respectively provided with two fulcrums of rotation 1a, namely there are four fulcrums of rotation 1a. At least four spherical segments 28 in one-to-one correspondence with the balls 3 are arranged at a periphery of the inner ball holder 2. The spherical segment 28 can restrict translational degrees of freedom of the inner ball holder 2 while retaining only rotational degrees of freedom of the inner ball holder 2, i.e., the inner ball holder 2 is constrained to rotate exclusively about a fixed point, thereby preventing unnecessary displacement of the inner ball holder 2 to avoid deviation in the sensing of an angle of the inner ball holder 2 by a position sensor 15. A center of each of the at least four spherical segments 28 coincides with a center of rotation 27. The center of rotation 27 passes through or approximately passes through an optical axis Z of the lens. The case where the center of rotation 27 approximately passes through the optical axis Z of the lens means that a minimum distance between the center of rotation 27 and the optical axis Z of the lens is less than or equal to 20% of a cross-sectional diameter of the stabilizing-focusing motor, and the ball 3 abuts against the spherical segment 28. By adopting a design in which the spherical segments 28 are concentric, it is beneficial to reduce frictional force when the inner ball holder 2 rotates, thereby reducing energy loss and power consumption during stabilization. The stabilizing magnet 4 and the stabilizing coil 5 can drive the inner ball holder 2 to rotate around at least two axes of rotation, each of the two axes of rotation being an axis of any angle that passes through or approximately passes through the center of rotation 27. Four balls 3 are arranged between the two portions of the outer ball holder 1 and the inner ball holder 2. The four balls 3 respectively abut against the four concentric spherical segments 28 of the inner ball holder 2 in one-to-one correspondence. Thus, the two outer ball holders 1 can be connected to the inner ball holder 2 respectively through a set of balls 3, thereby achieving multi-axis rotational stabilization with a simple connection structure. And the four balls 3 can support the inner ball holder 2 stably and reliably to lessen impacts of an attitude error on stabilization.

In some preferred embodiments of the present disclosure, the outer ball holder 1 is provided with at least two portions. The at least two portions are spliced up and down. There are two sets of the balls 3. The two sets of the balls 3 are provided on the at least two portions of the outer ball holder 1 in one-to-one correspondence.

A horizontal plane of a center of rotation 27 is defined as a first reference plane 26. One set of the two sets of the balls 3 is located above the first reference plane 26, while the other one set of the two sets of the balls 3 is located under the first reference plane 26. In this way, the outer ball holder 1 and the inner ball holder 2 can be assembled more conveniently, the inner ball holder 2 can be supported stably, and the inner ball holder 2 is less affected by the altitude error in multi-axis rotational stabilization.

In some preferred embodiments of the present disclosure, the two sets of the balls 3 each include two balls. The two balls 3 above the first reference plane 26 are opposite to each other. The two balls 3 under the first reference plane 26 are adjacent to the two balls 3 above the first reference plane 26.

In some preferred embodiments of the present disclosure, the stabilizing structure 100 further includes a holder 9 provided on the outer ball holder 1, and configured to locate each of the balls 3. In this way, the holder 9 can keep the ball 3 at a designated position stably to ensure stability and reliability of the whole structure.

In some preferred embodiments of the present disclosure, the stabilizing structure 100 further includes a first magnet holder 8 provided on the inner ball holder 2. The stabilizing magnet 4 is provided on the first magnet holder 8. Specifically, with the first magnet holder 8, the stabilizing magnet 4 can be mounted conveniently. In response to assembly of the motor, the first magnet holder 8 provided with the stabilizing magnet 4 in advance can be assembled directly to improve an assembly efficiency. In addition, the stabilizing magnet 4 is replaced by directly changing the first magnet holder 8, which is simple and convenient, prevents damage to the inner ball holder 2 due to a direct replacement of the inner ball holder 2 or the stabilizing magnet 4, and reduces a maintenance cost.

In some preferred embodiments of the present disclosure, the stabilizing structure 100 further includes a first coil holder 7 provided on the outer ball holder 1. The stabilizing coil 5 is provided on the first coil holder 7. Specifically, with the first coil holder 7, the stabilizing coil 5 can be mounted conveniently. In response to assembly of the motor, the first coil holder 7 provided with the stabilizing coil 5 in advance can be assembled directly to improve an assembly efficiency. In addition, the stabilizing coil 5 is replaced by directly changing the first coil holder 7, which is simple and convenient, prevents damage to the outer ball holder 1 due to a direct replacement of the outer ball holder 1 or the stabilizing coil 5, and reduces a maintenance cost.

In some preferred embodiments of the present disclosure, the focusing structure 200 further includes a spring holder 25 provided on the second magnet holder 10. The connecting spring 12 is provided on the spring holder 25. Specifically, the connecting spring 12 can be connected to the lens carrier 11 and the second magnet holder 10 through the spring holder 25. With the spring holder 25, the connecting spring 12 can be connected conveniently, the position of the connecting spring 12 is ensured to be accurate, and the motor is also assembled conveniently.

In some preferred embodiments of the present disclosure, the focusing structure 200 further includes a position magnet 17 provided on the second magnet holder 10.

The preferred embodiment of the present disclosure further provides the application module of a stabilizing-focusing motor, including the stabilizing-focusing motor described above, and further including: a lens 300, an image module 400, a module housing 500, and a module circuit board 600.

The lens 300 is provided on the lens carrier 11.

The image module 400 is provided at a bottom end of the lens carrier 11, and corresponding to the lens.

The module housing 500 is connected to a bottom end of the outer ball holder 1.

The module circuit board 600 is provided in the module housing 500, and connected to the focusing structure 200 and the stabilizing structure 100.

In some preferred embodiments of the present disclosure, the image module 400 includes a sensor housing 18, an optical filter 19, an image sensor 20, and a sensor circuit board 21. The sensor housing 18 is connected to the focusing structure 200. The optical filter 19 and the sensor circuit board 21 are provided on the sensor housing 18. The image sensor 20 is provided on the sensor circuit board 21.

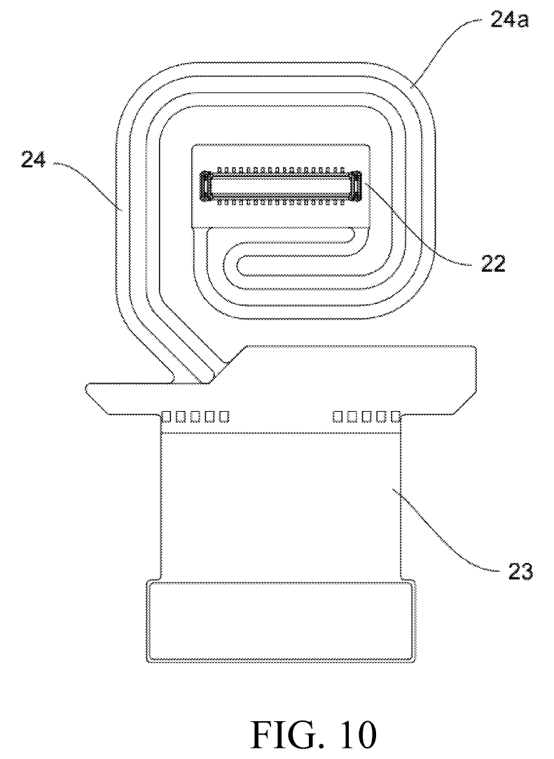

Referring to FIG. 10, in some preferred embodiments of the present disclosure, the module circuit board 600 includes a movable portion 22, an unmovable portion 23, and an elastic portion 24. The movable portion 22 is connected to the unmovable portion 23 through the elastic portion 24.

In some preferred embodiments of the present disclosure, the unmovable portion is extended out of the module housing 500. Both the elastic portion 24 and the movable portion are located in the module housing 500. The elastic portion 24 includes a spring wire. The spring wire includes one end connected to the movable portion, and the other end connected to the unmovable portion.

Further, the spring wire is provided with curved portions 24a and a linear portion. A plurality of the curved portions 24a are sequentially connected to the linear portion to form a vortex structure of the spring wire, thereby achieving desirable damp and rebound effects.

Further, the module circuit board 600 is connected to the sensor circuit board 21 through a module socket.

In some preferred embodiments of the present disclosure, the stabilizing structure 100 further includes the position sensor 15 provided on the stabilizing circuit board 6, and corresponding to the stabilizing magnet 4. Specifically, the position sensor 15 is connected to the external or internal control driver chip through the stabilizing circuit board 6. The control driver chip can read a signal of the position sensor 15, and sense angles of the stabilizing magnet 4 and the inner ball holder 2, thereby realizing closed-loop stabilizing control.

The present disclosure has a following working process: An external device is connected to the module circuit board 600. The module circuit board 600 is connected to the sensor circuit board 21, the stabilizing circuit board 6, and the focusing circuit board 16. In response to stabilization in photographing, the stabilizing coil 5 is powered on. An Ampere force generated by the powered stabilizing coil 5 in a magnetic field of the stabilizing magnet 4 is applied to the inner ball holder 2, such that the inner ball holder 2 moves relative to the outer ball holder 1 under an action of the balls 3. In combination with an external or internal control driver chip, a direction and an amplitude of a current in the stabilizing coil 5 are controlled, thereby controlling an angle of the inner ball holder 2, counteracting vibration interferences in photographing to eliminate the blur of the image, and improving a quality of the image or film. Upon completion of photographing, the stabilizing coil 5 is powered off. Because of the rebound effect of the elastic portion 24, the inner ball holder 2 is reset automatically. In response to focusing in photographing, an Ampere force generated by the powered focusing coil 14 in a magnetic field of the focusing magnet 13 is applied to the lens carrier 11. In combination with the external control driver chip, a direction and an amplitude of a current in the focusing coil 14 are controlled, thereby controlling a displacement of the lens carrier 11, and realizing an auto-focusing function of the lens. Upon completion of photographing, the lens carrier 11 is reset automatically with the spring.

In conclusion, the stabilizing-focusing motor and the application module thereof provided by the preferred embodiment of the present disclosure achieve the following effects over the prior art:
(1) The stabilizing-focusing motor and the application module thereof provided by the present disclosure are structured simply, can support multi-axis movement and stabilization, and can be more advantageous in size, reliability and cost.
(2) The stabilizing-focusing motor and the application module thereof provided by the present disclosure employ an electromagnetic force driving actuator, rather than a complicated mechanical transmission structure, and thus have advantages of simple and compact structure, convenience in assembly, small size, light weight, low cost and low power consumption for large-scale production and application.
(3) The outer ball holder 1 is connected to the inner ball holder 2 through the balls 3. Since the outer ball holder 1 and the inner ball holder 2 are unnecessarily connected by other structures, the stabilizing-focusing motor and the application module thereof provided by the present disclosure have advantages of simple and compact structure, low manufacturing cost, light weight and small size.
(4) The stabilizing-focusing motor and the application module thereof provided by the present disclosure further drive the focusing structure 200 with an Ampere force generated by the powered focusing coil 14 in a magnetic field of the focusing magnet 13, and controls a direction of a current in the focusing coil 14 in combination with an external or internal control driver chip, thereby realizing an auto-focusing function of the lens, and making the focusing quick and accurate.

The above are only preferred implementations of the present disclosure. It should be noted that several improvements and replacements may further be made by a person of ordinary skill in the art without departing from the principle of the present disclosure, and such improvements and replacements should also be deemed as falling within the protection scope of the present disclosure.

1. A stabilizing-focusing motor, comprising:
a stabilizing structure comprising an outer ball holder, an inner ball holder, balls, a stabilizing magnet, a stabilizing coil, and a stabilizing circuit board, wherein the inner ball holder is provided in the outer ball holder, and connected to the outer ball holder through the balls; the stabilizing magnet is provided on the inner ball holder; the stabilizing coil is provided on the outer ball holder, and opposite to the stabilizing magnet; and the stabilizing circuit board is provided on the outer ball holder, and electrically connected to the stabilizing coil; and
a focusing structure comprising a second magnet holder, a lens carrier, a connecting spring, a focusing magnet, a focusing coil, and a focusing circuit board, wherein the second magnet holder is connected to the inner ball holder; the focusing magnet is provided on the second magnet holder; the lens carrier is connected to the second magnet holder through the connecting spring; the focusing coil is provided on the lens carrier; and the focusing circuit board is provided on the lens carrier, and electrically connected to the focusing coil;
wherein, at least four spherical segments in one-to-one correspondence with the balls are arranged at a periphery of the inner ball holder, a center of each of the spherical segments coincides with a center of rotation, and a minimum distance between the center of rotation and an optical axis Z of a lens is less than or equal to 20% of a diameter of a cross-section of the stabilizing-focusing motor.

2. The stabilizing-focusing motor according to claim 1, wherein the outer ball holder is provided with at least two portions; the at least two portions are spliced up and down; there are two sets of the balls; and the two sets of the balls are provided on the at least two portions of the outer ball holder in one-to-one correspondence; and
a horizontal plane of the center of rotation is defined as a first reference plane, and one set of the two sets of the balls is located above the first reference plane, while the other set of the two sets of the balls is located under the first reference plane.

3. The stabilizing-focusing motor according to claim 2, wherein the two sets of the balls each comprise two balls; the two balls above the first reference plane are opposite to each other; and the two balls under the first reference plane are adjacent to the two balls above the first reference plane.

4. The stabilizing-focusing motor according to claim 1, wherein the stabilizing structure further comprises a holder provided on the outer ball holder, and configured to locate each of the balls.

5. The stabilizing-focusing motor according to claim 1, wherein the stabilizing structure further comprises a first magnet holder provided on the inner ball holder; and the stabilizing magnet is provided on the first magnet holder.

6. The stabilizing-focusing motor according to claim 1, wherein the stabilizing structure further comprises a first coil holder provided on the outer ball holder; and the stabilizing coil is provided on the first coil holder.

7. The stabilizing-focusing motor according to claim 1, wherein the focusing structure further comprises a spring holder provided on the second magnet holder; and the connecting spring is provided on the spring holder.

8. An application module of a stabilizing-focusing motor, comprising the stabilizing-focusing motor according to claim 1, and further comprising:
the lens provided on the lens carrier;
an image module provided at a bottom end of the lens carrier, and corresponding to the lens;
a module housing connected to a bottom end of the outer ball holder; and
a module circuit board provided in the module housing, and connected to the focusing structure and the stabilizing structure.

9. An application module of a stabilizing-focusing motor, comprising the stabilizing-focusing motor according to claim 2, and further comprising:
the lens provided on the lens carrier;
an image module provided at a bottom end of the lens carrier, and corresponding to the lens;
a module housing connected to a bottom end of the outer ball holder; and
a module circuit board provided in the module housing, and connected to the focusing structure and the stabilizing structure.

10. An application module of a stabilizing-focusing motor, comprising the stabilizing-focusing motor according to claim 3, and further comprising:
the lens provided on the lens carrier;
an image module provided at a bottom end of the lens carrier, and corresponding to the lens;
a module housing connected to a bottom end of the outer ball holder; and
a module circuit board provided in the module housing, and connected to the focusing structure and the stabilizing structure.

11. An application module of a stabilizing-focusing motor, comprising the stabilizing-focusing motor according to claim 4, and further comprising:
the lens provided on the lens carrier;
an image module provided at a bottom end of the lens carrier, and corresponding to the lens;
a module housing connected to a bottom end of the outer ball holder; and
a module circuit board provided in the module housing, and connected to the focusing structure and the stabilizing structure.

12. An application module of a stabilizing-focusing motor, comprising the stabilizing-focusing motor according to claim 5, and further comprising:
the lens provided on the lens carrier;
an image module provided at a bottom end of the lens carrier, and corresponding to the lens;
a module housing connected to a bottom end of the outer ball holder; and
a module circuit board provided in the module housing, and connected to the focusing structure and the stabilizing structure.

13. An application module of a stabilizing-focusing motor, comprising the stabilizing-focusing motor according to claim 6, and further comprising:
the lens provided on the lens carrier;
an image module provided at a bottom end of the lens carrier, and corresponding to the lens;
a module housing connected to a bottom end of the outer ball holder; and
a module circuit board provided in the module housing, and connected to the focusing structure and the stabilizing structure.

14. An application module of a stabilizing-focusing motor, comprising the stabilizing-focusing motor according to claim 7, and further comprising:
the lens provided on the lens carrier;
an image module provided at a bottom end of the lens carrier, and corresponding to the lens;
a module housing connected to a bottom end of the outer ball holder; and
a module circuit board provided in the module housing, and connected to the focusing structure and the stabilizing structure.

15. The application module of a stabilizing-focusing motor according to claim 8, wherein the image module comprises a sensor housing, an optical filter, an image sensor, and a sensor circuit board; the sensor housing is connected to the focusing structure; the optical filter and the sensor circuit board are provided on the sensor housing; and the image sensor is provided on the sensor circuit board.

16. The application module of a stabilizing-focusing motor according to claim 9, wherein the image module comprises a sensor housing, an optical filter, an image sensor, and a sensor circuit board; the sensor housing is connected to the focusing structure; the optical filter and the sensor circuit board are provided on the sensor housing; and the image sensor is provided on the sensor circuit board.

17. The application module of a stabilizing-focusing motor according to claim 10, wherein the image module comprises a sensor housing, an optical filter, an image sensor, and a sensor circuit board; the sensor housing is connected to the focusing structure; the optical filter and the sensor circuit board are provided on the sensor housing; and the image sensor is provided on the sensor circuit board.

18. The application module of a stabilizing-focusing motor according to claim 12, wherein the image module comprises a sensor housing, an optical filter, an image sensor, and a sensor circuit board; the sensor housing is connected to the focusing structure; the optical filter and the sensor circuit board are provided on the sensor housing; and the image sensor is provided on the sensor circuit board.

19. The application module of a stabilizing-focusing motor according to claim 13, wherein the image module comprises a sensor housing, an optical filter, an image sensor, and a sensor circuit board; the sensor housing is connected to the focusing structure; the optical filter and the sensor circuit board are provided on the sensor housing; and the image sensor is provided on the sensor circuit board.

20. The application module of a stabilizing-focusing motor according to claim 15, wherein the module circuit board comprises a movable portion, an unmovable portion, and an elastic portion; and the movable portion is connected to the unmovable portion through the elastic portion.
